(19) United States
(12) Patent Application Publication
(10) Pub. No.: US 2006/0224695 A1
(43) Pub. Date: Oct. 5, 2006

(54) Method and apparatus for remote reporting of impression data using log files

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 11/397,735

(22) Filed: Apr. 5, 2006

Related U.S. Application Data
(60) Provisional application No. 60/668,081, filed on Apr. 5, 2005.

(51) Int. Cl. G06F 15/16

(52) U.S. Cl. 709/217

(57) ABSTRACT

A system and method for generating log files that store information regarding the presentation of advertisements in video games is described. The log file is copied to a server when a suitable network connection is available. The log file comprises a public portion and a private portion. The public portion comprises information that is used to route the log file to a suitable destination. The private portion contains optionally encrypted to complicate unauthorized access thereto.

### FIELD OF THE INVENTION

The invention relates to network communications and more specifically to auditable data reporting data.

### BACKGROUND OF THE INVENTION

In order to provide exposure of the products and services of their clients, advertisers are turning from traditional methods of advertising such as television, radio and signage to advertising using computing platforms. One such approach involves displaying advertisements to a person playing a video game, a gamer. In the art, providing an advertisement to a target individual is referred to as an impression and can include audio impressions, video impressions, images, etc. One complication in providing such impressions is that it is often difficult to determine exactly what a person playing a game has seen over the course of an extended period of time. Additionally, as video games increase in popularity and the use of advertising in video games increases, it is apparent that a substantial amount of data is necessary to provide reports associated with impressions provided to a group of users as well as some relative measure of the quality of the impressions.

A further complication is that data associated with advertising impressions is valuable. Specifically, unscrupulous persons might be inclined to provide reports falsely indicating that impressions that have not occurred have occurred. This benefits these persons by supporting a fictitious invoice for advertising impressions that were not impressed upon gamers. For example, Internet banner advertising was subject to significant problems when software robots were used to revisit a page including the banner repeatedly and automatically in order to artificially inflate impression counts. Advertisers who paid for advertising based on impression counts were thereby overpaying, paying based on less than honest statistical data. Clearly, advertisers do not want to overpay.

It would be beneficial to provide a system for effectively and accurately providing data associated with advertising in video games. Additionally, it would be beneficial if such a system provides data that is difficult to counterfeit or inflate.

### SUMMARY OF THE INVENTION

In accordance with another embodiment of the invention there is provided a non volatile storage medium having instruction data stored therein, the data for, when executed resulting in: generating a log file, the log file comprising: a public portion indicative of an identity of the log file; and, a private portion for storing data associated with an advertisement provided to a user during execution of the instructions by the processor, identifying a data connection to an external server, the instructions for establishing a threshold and upon overcoming the threshold, providing a copy of the log file to the external server; and, impressing advertisements upon a gamer.

In accordance with another embodiment of the invention there is provided a method of recording data associated with a presentation of an advertisement on a computing device, comprising: providing media to user of the computing device, the media comprising an advertisement; generating a public portion of a log file in a memory of the computing device; generating a private portion of the log file, the private portion comprising data associated with the advertisement; storing the log file in a memory of the computing device; determining a threshold; upon overcoming the threshold, determining a presence of a data connection to an external server and providing a copy of the log file to the external server.

In accordance with another embodiment of the invention there is provided a method of recording data associated with a presentation of an advertisement on a computing device, comprising: providing media to user of the computing device, the media comprising an advertisement; storing data within a public portion of a log file in a memory of the computing device; storing data within a private portion of the log file, the private portion comprising data associated with the advertisement; storing the log file in a memory of the computing device; determining a threshold; upon overcoming the threshold, determining a presence of a data connection to an external server and providing a copy of the log file to the external server.

### BRIEF DESCRIPTION OF THE DRAWINGS

The invention is now described with reference to the figures in which:

FIG. 1 is a schematic diagram of video game advertising system; and,

FIG. 2 is a drawing representative of the contents of a log file.

### DETAILED DESCRIPTION OF THE INVENTION

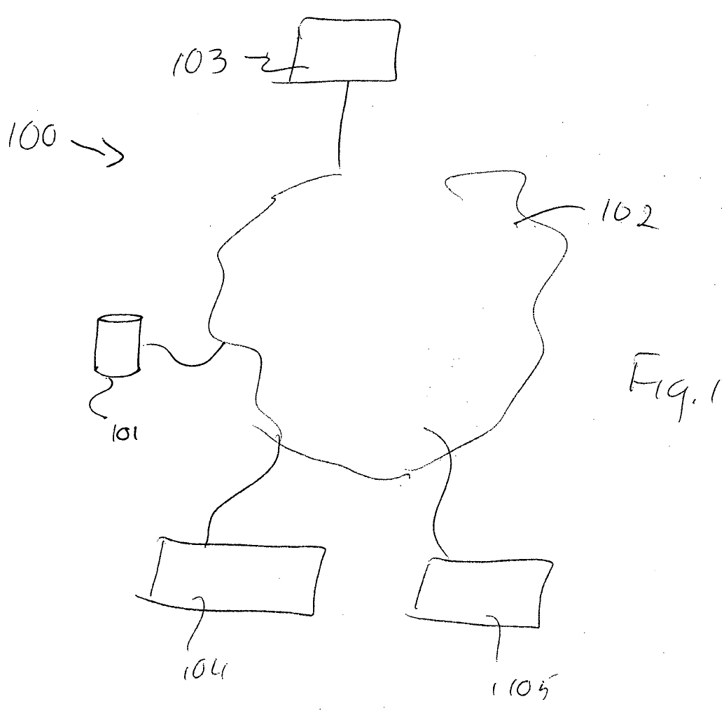

Referring to FIG. 1, a schematic diagram of a video game advertising system according to an embodiment of the invention is shown. The advertising system 100 comprises: a game server 101, a public network 102, an advertising server 103, a first gaming device 104 and a second gaming device 105. In use a user of the first gaming device 104 initiates a video game session by executing a video game application. The video game application comprises instructions for the video game and for supporting delivery and display of advertisements, in the form of product placement advertisements within the game, interstitial advertisements, video advertisements, sound files, images, and splash screens. During the video game session a first advertisement is presented to a player of the video game. Impression data associated with the advertising impression is stored in a memory of the gaming device 104. The impression data is stored securely in a log file. If no log file is detected at a known memory location then a new log file is created. A person of skill in the art will appreciate that the known memory location is typically provided in a same device housing as the gaming device 104. Alternatively, many platforms support memories that are viewed as external to the gaming device 104 and are suitable for storing of log files therein. For example, in some video game consoles, data is stored via an external proxy. When a second impression related to the first advertisement is provided, the log file is updated to reflect a record of the second impression. The log file is updated until a threshold is exceeded. When the threshold is exceeded the first gaming device 104 verifies the integrity of a data communication path to the advertising server 103 and when the data communication path is determined to be reliable, data associated with the log file is transferred from the first gaming device 104 to a server, for example the advertising server 103. Once the data is transferred to the server, the log file residing on the first gaming device 104 is cleared. Alternatively, the log file is maintained but modified to reflect the transfer of the data. Further alternatively, the log file is deleted. Similarly, when the second gaming device 105 is used it provides advertisements during the resulting gaming session. The impressing of these advertisements is recorded in a log file within a memory accessible to the second gaming device 105. When a predetermined criterion is met the second gaming device 105 acts to provide the log file to an external server. Clearly, when the gaming devices 104 and 105 are in data communication via the Internet the opportunity to provide log files to advertising server 103 is supported. Optionally, the first and second gaming devices 104 and 105 store data comprising a unique identifier. The log file uses the unique identifier to ensure that a log file from a first source is not confused with a log file from a second other source. Further optionally, the software in execution on the first and second gaming devices comprise unique identifier data for a given software program. The software unique identifier is optionally used in the generating of the log file thereby allowing log files to be associated with specific copies of a given software program.

The log file supports efficient modification to permit reception of new data associated with impressions provided to the user. As these impressions are optionally provided to the video game after the programming of the video game is completed and distributed, it is desirable to know which advertisements and product placements are provided with a known video game and who has received the impressions and associated therewith. Additionally, the log file supports encryption of data stored therein. Thus, an unauthorized user reviewing the log file would have a difficult time correctly interpreting or altering the contents of the log file; however the log file remains relatively simple to update by an authorised software program. The log file is generated according to software instructions that prevent a malicious user from simply copying the log file for the purpose of deceiving an advertising server into acknowledging that an impression has occurred more often than it has. Thus, each log file supports unique keying to reduce a likelihood that any two log files are identical. Further, entries within a log file are keyed to prevent record playback attacks on impression data reliability. A person of skill in the art will understand and appreciate how uniquely keyed files are generated and used.

In order to facilitate updating of the log file, an application program interface (API) residing within a video game software program present on the first gaming device 104 is able to update log files that it generates. Additionally, a program provided on a master server is capable of correctly interpreting data stored in log files from a variety of predetermined supported sources. This type of encryption scheme is often referred to as “write once encryption.” A person of skill in the art will appreciate that there are a variety of write once encryption methodologies that support such encryption and updating functionality.

Optionally, different games provided on a given video game device support distinct log files. Ideally, log files are stored in a non-volatile memory of the video game device however this need not be the case. In an alternative embodiment, the log file is automatically uploaded to a non-volatile memory external to the video game device when other data is uploaded from the video game device. Thus, in a video game console that does not support non-volatile memory but does support Internet connectivity, when data associated with a game session is uploaded to a game server the log file is provided to the server, for example the game server, as well. Alternatively, the log file is provided to another server when the game establishes a connection with the Internet. Clearly, in order to maintain integrity of the log file, when the log file is uploaded to an external servers it is either erased or initialized on the video gaming device.

The log files mitigate a variety of problems associated with the accurate reporting of the delivery of advertising content on a computing device. Since the log files have a private portion, creating counterfeit log files is difficult. Similarly, when the log files are generated with a unique identifier copied log files are easily identified thereby complicating the production of illegitimate log files. Additionally, since the log files are optionally updated with new data prior to being sent to an external server, the number of files being sent to the external server is more easily managed.

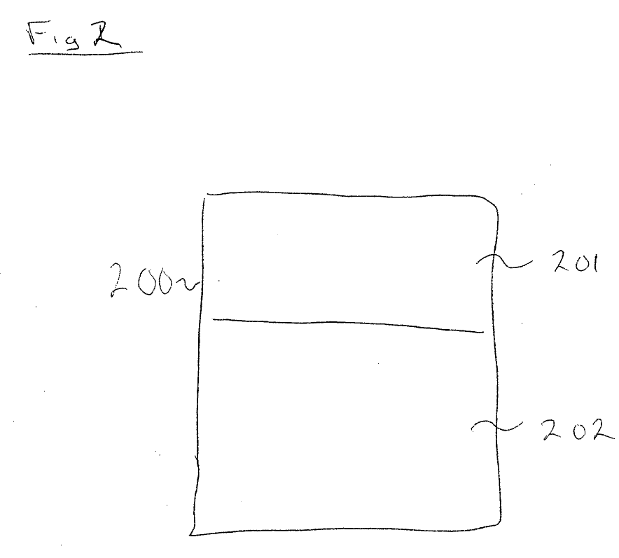

Referring to FIG. 2, a log file 200 comprises: a public portion 201 supporting a file name, and a private portion 202 for storing data associated with advertising impressions. Clearly, a wide variety of variations in the log file are optionally supported. For example, the data stored within the private portion of the log file is optionally encrypted using any of a variety of suitable encryption techniques. Additionally, the public portion of the log file optionally includes a variety of data relating the origin of the log file. Thus, in addition to providing a title for the log file, the public portion of the log file optionally supports additional data storage indicative of: the identity of the game, the company that distributes the game, demographic data of the a registered user of the game, a rating of the game, an identifier of the advertiser, an identifier of a type of advertisement, a descriptor of the video game device among others. Clearly, other data is optionally provided in the public portion of the log file. A person of skill in the art will appreciate that while it is beneficial to provide data in the public portion it is also desirable to minimize the overall size of the log file in order to minimize the demands placed on the memory used for storing log files. Similarly, the private portion of the log file optionally supports a variety of data. For example, the private portion of the log file optionally comprises data relating to any of the data described in the public portion in addition to discreet sets of data, each set of data relating to a type of advertisement or product placement, a quality of the advertisement or product placement and a duration of the advertisement or product placement. A person of skill in the art will appreciate that there are a variety of criteria that are related to the quality of an advertising impression. For example, in the case of a visual advertisement the size of the advertisement and the location of advertisement within a viewable area of a display device are such criteria. Similarly a high quality impression is provided when the advertisement is provided in a way that results in the gamer interacting with the advertisement. A person of skill in the art will appreciate that these criteria vary with the type of advertisement being impressed.

A person of skill in the art will appreciate that the log files described with reference to embodiments of the invention are also suitable in other applications. For example, log files are optionally used to track product placements in suitably programmed media decoders, such as an application that provides a movie from an optical disc such as a digital versatile disc (DVD) in a personal computer. Assuming that the movie is properly encoded and designed to receive suitable product placements, the log file is useful in providing feedback associated with those advertisements that have been properly provided. Optionally, a suitably encoded media stream comprises identifiers that associate the presentation of a portion of the media stream with a predetermined set of advertisements. These advertisements are part of the original media stream and are not subject to deletion or overwriting by dynamic product placements. Such advertising content is referred to as static content. Data associated with the media stream provides information suitable for generating a corresponding log file. Thus, for example, when a scene with a predetermined static advertisement is shown in the normal viewing of the media stream, the data associated with that portion of the media stream contains information associated with advertisements that are presented. This data is then used in generating a corresponding log file.

Alternatively, instead of maintaining a single log file for a single game, a log file is maintained for numerous games, for example, for all games by a same publisher. In such an example, log file maintenance is potentially complicated due to the consistency of the log file access software, but transmission of small log files is obviated thereby improving communication efficiency and server efficiency. Within a log file of this type, game related data such as a game identifier is stored for each log entry to identify not only the advertisement, but the game within which the advertisement is displayed. Alternatively, all advertising data is recorded within the log file by a process that is industry standard allowing for a single log file to be maintained for numerous games and even for numerous publishers. Optionally, for each impression a unique impression location identifier is stored indicating the exact game and location within the game where the impression was made.

Numerous other embodiments of the invention will be apparent to one of skill in the art without departing from the spirit and scope of the invention.

What is claimed is:

1. A non-volatile storage medium having instruction data stored therein, the data for, when executed resulting in:
generating a log file, the log file comprising:
a public portion indicative of an identity of the log file; and,
a private portion for storing data associated with an advertisement provided to a user during execution of the instructions by the processor,
identifying a data connection to an external server, the instructions for establishing a threshold and upon overcoming the threshold, providing a copy of the log file to the external server; and,
impressing advertisements upon a gamer.

2. A non-volatile memory of a computing device according to claim 1, wherein the program data corresponds to a video game program.

3. A non-volatile memory of a computing device according to claim 2, comprising instructions for receiving an advertisement from an external advertisement server via the network connection.

4. A non-volatile memory of a computing device according to claim 2, comprising instructions for:
determining that an advertisement has been provided to a user;
reading a log file from the non-volatile memory;
updating log file in a manner indicative of the providing of the advertisement to the user; and,
saving the log file to the non-volatile memory.

5. A non-volatile memory of a computing device according to claim 4, wherein the computing device is a game console.

6. A non-volatile memory of a computing device according to claim 4, wherein the computing device is a personal computer.

7. A non-volatile memory of a computing device according to claim 1, wherein the private portion is for storing data corresponding to quality of the advertisement.

8. A non-volatile memory of a computing device according to claim 7, wherein the data corresponding to quality of the advertisement comprises data indicative of a duration.

9. A non-volatile memory of a computing device according to claim 7, wherein the data corresponding to quality of the advertisement comprises data associated with a relative size of an advertisement image.

10. A non-volatile memory of a computing device according to claim 8, wherein the data corresponding to quality of the advertisement comprises data associated with a relative size of an advertisement image.

11. A non-volatile memory of a computing device according to claim 8, wherein the program data corresponding to instructions for being executed by a processor comprises instructions for generating very large numbers of security keys.

12. A method of recording data associated with a presentation of an advertisement on a computing device, comprising:
providing media to user of the computing device, the media comprising an advertisement;
generating a public portion of a log file in a memory of the computing device;
generating a private portion of the log file, the private portion comprising data associated with the advertisement;
storing the log file in a memory of the computing device;
determining a threshold;
upon overcoming the threshold, determining a presence of a data connection to an external server and providing a copy of the log file to the external server.

13. A method of recording data associated with a presentation of an advertisement on a computing device according to claim 12, wherein providing media to user comprises running video game software.

14. A method of recording data associated with a presentation of an advertisement on a computing device according to claim 13, comprising:
upon providing the copy of the log file to the external server erasing the log file from the memory of the computing device.

15. A method of recording data associated with a presentation of an advertisement on a computing device according to claim 13, wherein the memory of the computing device is a non-volatile memory.

16. A method of recording data associated with a presentation of an advertisement on a computing device according to claim 15, wherein the computing device is a game console.

17. A method of recording data associated with a presentation of an advertisement on a computing device according to claim 15, wherein the computing device is a personal computer.

18. A method of recording data associated with a presentation of an advertisement on a computing device according to claim 13, wherein generating the private portion of the log file comprises encrypting data associated with the advertisement and storing the log file comprises storing the encrypted data.

19. A method of recording data associated with a presentation of an advertisement on a computing device according to claim 18, wherein the data associated with the advertisement comprises impression quality data.

20. A method of recording data associated with a presentation of an advertisement on a computing device according to claim 19, wherein the impression quality data comprises data associated with a duration of the advertisement.

21. A method of recording data associated with a presentation of an advertisement on a computing device according to claim 20, wherein the private portion of the log file is encrypted using write once encryption.

22. A method of recording data associated with a presentation of an advertisement on a computing device, comprising:
providing media to user of the computing device, the media comprising an advertisement;
storing data within a public portion of a log file in a memory of the computing device;
storing data within a private portion of the log file, the private portion comprising data associated with the advertisement;
storing the log file in a memory of the computing device;
determining a threshold;
upon overcoming the threshold, determining a presence of a data connection to an external server and providing a copy of the log file to the external server.

23. A method of recording data associated with a presentation of an advertisement on a computing device according to claim 18, comprising:
providing a second advertisement;
determining if a log file corresponding to the second advertisement is stored in the memory; and,
upon determining that suitable log file is stored in the memory:
loading the log file;
updating the private portion of the log file thereby generating a new version of the log file; and,
saving the new version of the log file to the memory.

24. A method of recording data associated with a presentation of an advertisement on a computing device according to claim 23, comprising:
upon storing the updated log file, incrementing a counter associated with the threshold and wherein overcoming the threshold corresponds to the counter exceeding a predetermined value.

25. A method of recording data associated with a presentation of an advertisement on a computing device according to claim 18, comprising:
saving the log file to a memory of the external server; and,
decrypting the private portion of the log file.

26. A method of recording data associated with a presentation of an advertisement on a computing device according to claim 25, comprising: recording data associated with an identifier of the private portion of the log file.

27. A method of recording data associated with a presentation of an advertisement on, a computing device according to claim 26, comprising:
upon decrypting the private portion of the log file, determining an identifier of the private portion;
verifying that the identifier for the private portion not consistent with any of a set of previously recorded identifiers stored in a memory accessible by the external server; and,
upon verifying that the identifier of the is consistent with a previously recorded identifier, erasing the log file from the memory of the external server.
